(19) United States
(12) Patent Application Publication
(10) Pub. No.: US 2014/0202167 A1
(43) Pub. Date: Jul. 24, 2014

(54) POWER GENERATION SYSTEM

(71) Applicant: MITSUBISHI HEAVY INDUSTRIES, LTD., Tokyo (JP)

(72) Inventors: Ryutaro Mori, Tokyo (JP); Hiroyuki Ozawa, Tokyo (JP); Haruki Mukumoto, Tokyo (JP); Norihisa Matake, Tokyo (JP)

(73) Assignee: MITSUBISHI HEAVY INDUSTRIES, LTD., Tokyo (JP)

(21) Appl. No.: 14/154,639

(22) Filed: Jan. 14, 2014

(30) Foreign Application Priority Data
Jan. 18, 2013 (JP) 2013-007758

(51) Int. Cl. F02C 6/00

(52) U.S. Cl. CPC F02C 6/00
USPC 60/793

(57) ABSTRACT

The power generation system includes a fuel cell that generates electric power using a fuel gas, a gas turbine including an air compressor, a combustor, and a turbine, an exhaust fuel line that introduces an exhaust fuel gas discharged from the fuel cell into the combustor, a branch exhaust fuel line branching off midway from the exhaust fuel line, a switching unit that sends the exhaust fuel gas to one of the branch exhaust fuel line and the combustor, and a heating portion that heats the exhaust fuel line at a downstream side of the switching unit.

### BACKGROUND OF THE INVENTION

1. Field of the Invention

The present invention relates to a power generation system, and more particularly, to a power generation system that is at least equipped with a fuel cell and a gas turbine.

Priority is claimed on Japanese Patent Application No. 2013-007758, filed Jan. 18, 2013, the content of which is incorporated herein by reference.

2. Description of Related Art

Due to low pollution and high power generation efficiency, fuel cells have recently come to be expected to be used in various fields. As a high-efficiency power generation system using the fuel cell, a combined power generation system in which, since the fuel cell is operated at a high temperature, the fuel cell works together with a gas turbine, and further works together with a steam turbine using a high-temperature exhaust gas from the gas turbine is known.

In the combined power generation system, the fuel cell is installed upstream from a combustor of the gas turbine, and an exhaust fuel gas containing an unburnt portion of fuel (remaining fuel) discharged from the fuel cell is introduced into the combustor of the gas turbine. That is, the fuel cell and the combustor of the gas turbine are connected by a pipe. Thereby, the entire fuel can be used for power generation. On the other hand, air is pressurized by an air compressor, and is fed to the fuel cell. The air is used as an oxidant, and then is sent to the gas turbine along with high-temperature exhaust heat. In the gas turbine, sensible heat and pressure of high-temperature high-pressure air are also converted into electric power as a part of a heat source. In the entire system, high power generation efficiency is obtained.

### CITATION LIST

### Patent Literature

### [Patent Literature 1]

Japanese Unexamined Patent Application, First Publication No. 2010-146934

### SUMMARY OF THE INVENTION

### Problem to be Solved by the Invention

The combined power generation system discharges exhaust fuel gas, which is discharged from the fuel cell, from a vent line connected to the pipe via a switching valve in a stage other than normal operation such as in the event of starting. The combined power generation system switches the switching valve so as to introduce the exhaust fuel gas into the combustor in a stage in which conditions in which the normal operation is possible are met.

However, when the pipe downstream from the switching valve is not raised in temperature in the switching stage, condensed drainage generated inside the pipe by condensation of moisture contained in the exhaust fuel gas flows into the combustor. Due to the inflow of the condensed drainage, turbine blades or the combustor may be damaged.

The present invention provides a power generation system capable of preventing turbine blades or a combustor from being damaged when switching to normal operation in which a fuel cell and a gas turbine of the power generation system work together with each other.

### Means for Solving the Problem

According to a first aspect of the present invention, a power generation system includes: a fuel cell that generates electric power using a fuel gas; a gas turbine including an air compressor, a combustor, and a turbine; an exhaust fuel line that introduces an exhaust fuel gas discharged from the fuel cell into the combustor; a branch exhaust fuel line branching off midway from the exhaust fuel line; a switching unit that sends the exhaust fuel gas to one of the branch exhaust fuel line and the combustor; and a heating portion that heats the exhaust fuel line at a downstream side of the switching unit.

According to the aforementioned aspect, as the heating portion is installed on the exhaust fuel line at the downstream side of the switching unit, the exhaust fuel line can be pre-heated. Since the exhaust fuel line is pre-heated by the heating portion, moisture contained in the exhaust fuel gas can be prevented from being condensed into drainage in the exhaust fuel line. Thereby, it is possible to prevent the condensed drainage from flowing into the combustor of the gas turbine and damaging the combustor or the turbine blades configuring the turbine.

According to a second aspect of the present invention, the power generation system may further include a gas turbine exhaust gas duct that emits an exhaust gas discharged from the turbine. The heating portion may use the exhaust gas passing through the gas turbine exhaust gas duct as a heat source.

According to the aforementioned aspect, since no energy is required to operate the heating portion, it is possible to prevent plant efficiency from being reduced.

According to a third aspect of the present invention, in the power generation system, the exhaust fuel line may pass through an interior of the gas turbine exhaust gas duct.

According to the aforementioned aspect, the heating portion can be configured with a simpler configuration.

According to a fourth aspect of the present invention, the power generation system may further include an exhaust oxidant gas line that introduces an oxidant gas discharged from the fuel cell into the combustor. The heating portion may use the exhaust oxidant gas passing through the exhaust oxidant gas line as a heat source.

According to a fifth aspect of the present invention, the power generation system may further include an oxidant gas line that introduces an oxidant gas discharged from the air compressor into the fuel cell. The heating portion may use the oxidant gas passing through the oxidant gas line as a heat source.

According to a sixth aspect of the present invention, in the power generation system, the heating portion may use the exhaust fuel gas passing through the branch exhaust fuel line as a heat source.

According to a seventh aspect of the present invention, the power generation system may further include a drainage separator that separates moisture contained in the exhaust fuel gas. The drainage separator may be installed on the exhaust fuel line at an upstream side of the switching unit.

According to the aforementioned power generation system, the heating portion is provided at the downstream side of the switching unit installed on the exhaust fuel line connecting the fuel cell and the combustor of the gas turbine. Thereby, the exhaust fuel line can be pre-heated before the combustor. Since the exhaust fuel line is pre-heated by the heating portion, moisture contained in the exhaust fuel gas can be prevented from being condensed and generating drainage in the exhaust fuel line. Thereby, it is possible to prevent the condensed drainage from flowing into the combustor of the gas turbine and damaging the combustor or the turbine blades configuring the turbine.

### BRIEF DESCRIPTION OF THE DRAWINGS

FIG. 1 is a system diagram of a combined power generation system according to a first embodiment of the present invention.

FIG. 2 is a schematic diagram showing a schematic constitution of a fuel cell module according to the first embodiment of the present invention.

FIG. 3 is a cross-sectional diagram showing a main portion of a cell stack according to the first embodiment of the present invention.

FIG. 4 is a cross-sectional diagram showing a cartridge according to the first embodiment of the present invention.

FIG. 5 is a perspective diagram showing a cartridge according to the first embodiment of the present invention.

FIG. 6 is a detailed perspective diagram showing a heating portion according to the first embodiment of the present invention.

FIG. 7 is a system diagram of a combined power generation system according to a second embodiment of the present invention.

FIG. 8 is a system diagram of a combined power generation system according to a third embodiment of the present invention.

FIG. 9 is a system diagram of a combined power generation system according to a fourth embodiment of the present invention.

FIG. 10 is a system diagram of a combined power generation system according to a fifth embodiment of the present invention.

### DETAILED DESCRIPTION OF THE INVENTION

### First Embodiment

Hereinafter, a first embodiment of the present invention will be described in detail with reference to the drawings.

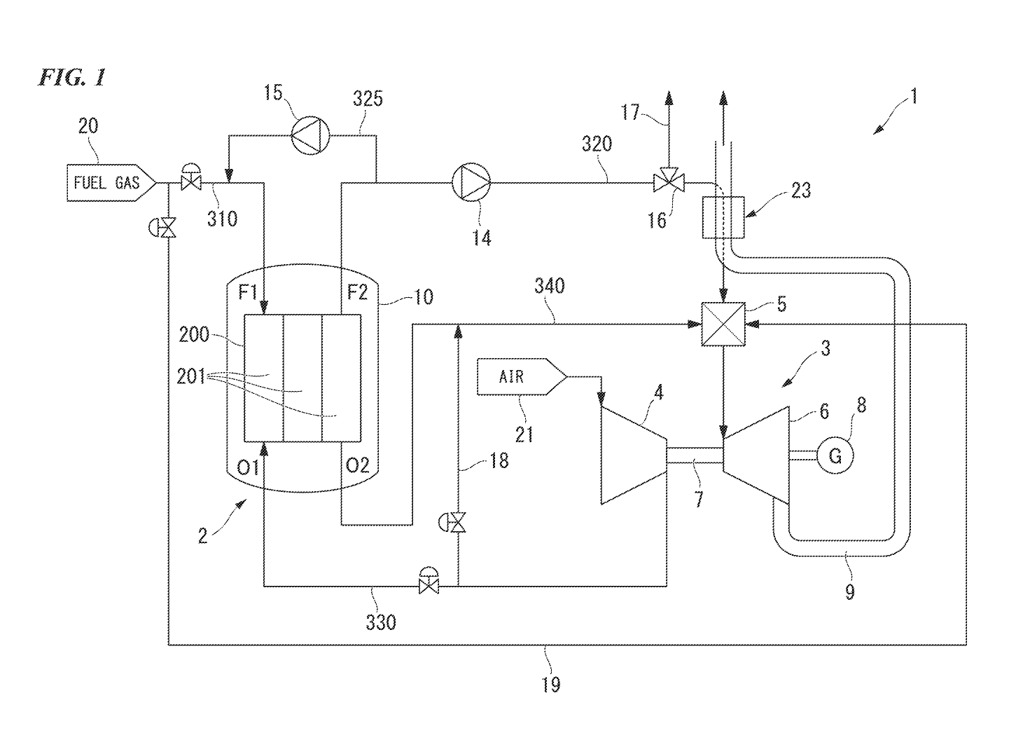

As shown in FIG. 1, a combined power generation system 1 of the present embodiment is a power generation system in which a fuel cell module 2 and a gas turbine 3 are combined.

The gas turbine 3 has an air compressor 4 that suctions and compresses external air, a combustor 5 provided on a downstream side of the air compressor 4, and a turbine 6 provided on a downstream side of the combustor 5 as main components. Further, an electric generator 8 is connected to the gas turbine 3. Alternatively, to use an exhaust gas of the gas turbine 3, an exhaust heat recovery boiler and a steam turbine (which are not shown) may be installed on the combined power generation system 1 of the present embodiment.

The combustor 5 injects a fuel gas into air, and generates a high-temperature combustion gas. The turbine 6 is fed with the high-temperature combustion gas generated by the combustor 5, and generates a rotational driving force. The rotational driving force generated by the turbine 6 rotates the air compressor 4 and drives the electric generator 8.

The turbine 6 is provided with a gas turbine exhaust gas duct 9 into which the high-temperature combustion gas, i.e. the exhaust gas, is introduced after the turbine 6 is rotatably driven. The gas turbine exhaust gas duct 9 is a pipe that guides the exhaust gas to the outside. The gas turbine exhaust gas duct 9 is a duct through which the exhaust gas is guided out in whole or in part.

The fuel cell module 2 has a pressure vessel 10 and a plurality of cartridges 201 (cartridge group 200) housed inside the pressure vessel 10. The cartridges 201 are fed with the fuel gas F1 and an oxidant gas O1 so as to produce electric power.

The cartridges 201 are connected to an oxidant gas pipe 330 feeding the oxidant gas O1 from the gas turbine 3, and a fuel pipe 310 feeding the fuel gas F1 from a fuel feeder 20.

As the fuel gas F1, for instance, hydrogen, carbon monoxide, or a hydrocarbon gas such as methane; a gas obtained by gasifying a carbonaceous material such as coal, or a gas containing two or more of these components is used. Further, as the oxidant gas O1, for instance, a gas containing 15 to 30% of oxygen is used. As the representative oxidant gas O1, air is used, but a mixed gas of a combustion exhaust gas and air or a mixed gas of oxygen and air may be used.

Furthermore, the combined power generation system 1 is provided with an exhaust oxidant gas pipe (exhaust oxidant gas line) 340 feeding an exhaust oxidant gas O2 that has been used for power generation in the cartridges 201 to the combustor 5 of the gas turbine 3, and an exhaust fuel pipe (exhaust fuel line) 320 feeding a fuel gas (exhaust fuel gas F2) discharged from the cartridges 201 to the combustor 5.

The exhaust fuel pipe 320 is provided with a blower 14 that pressurizes the exhaust fuel gas F2 flowing through the exhaust fuel pipe 320. The exhaust fuel gas F2 includes the fuel gas that is used for power generation and the fuel gas that is not used for power generation.

The oxidant gas pipe 330 is a pipe that guides the oxidant gas compressed in the air compressor 4 of the gas turbine 3 to the cartridges 201.

The exhaust fuel pipe 320 is connected to a fuel recirculation pipe 325 that returns a part of the exhaust fuel gas F2 to the fuel pipe 310 so as to be recirculated to the fuel cell module 2. In detail, a first end of the fuel recirculation pipe 325 is connected to the exhaust fuel pipe 320, and a second end is connected to the fuel pipe 310. The fuel recirculation pipe 325 is provided with a fuel recirculation blower 15 that pressurizes the exhaust fuel gas F2 flowing through the fuel recirculation pipe 325.

From the cartridges 201 toward the combustor 5, the exhaust fuel pipe 320 is sequentially provided with a joint with the fuel recirculation pipe 325 and a switching valve (switching unit) 16. A vent pipe (branch exhaust fuel line) 17 branches off from the switching valve 16. The vent pipe 17 is a pipe that discharges at least part of the exhaust fuel gas F2 flowing through the exhaust fuel pipe 320 to the outside. The switching valve 16 is a valve that sends the exhaust fuel gas F2 flowing through the exhaust fuel pipe 320 to one of the combustor 5 and the vent pipe 17, and a regulating valve that controls a flow rate and pressure of the exhaust fuel gas F2 discharged from the vent pipe 17 to the outside.

Further, the oxidant gas pipe 330 is provided with an air branch pipe 18 that branches the oxidant gas O1 to the exhaust oxidant gas pipe 340. Furthermore, the fuel pipe 310 is provided with a fuel branch pipe 19 that directly introduces the fuel gas F1 into the combustor 5.

The combined power generation system 1 of the present embodiment is provided with a heater 23 on the exhaust fuel pipe 320 on the downstream side of the switching valve 16. A heat source of the heater 23 is the high-temperature exhaust gas introduced into the gas turbine exhaust gas duct 9. In other words, the exhaust fuel pipe 320 is configured to pass through the interior of the gas turbine exhaust gas duct 9.

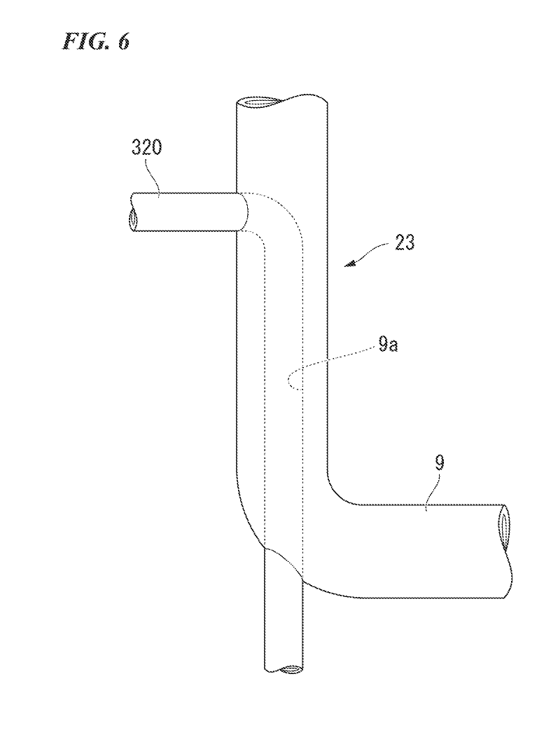

To be specific, as shown in FIG. 6, a tunnel-shaped tubular hole 9a, through which the exhaust fuel pipe 320 can pass and which secures airtightness of the gas turbine exhaust gas duct 9, is formed in the gas turbine exhaust gas duct 9. The exhaust fuel pipe 320 is disposed so that an outer circumferential surface thereof is in contact with an inner circumferential surface of the tubular hole 9a.

Next, a detailed structure of the fuel cell module 2 will be described.

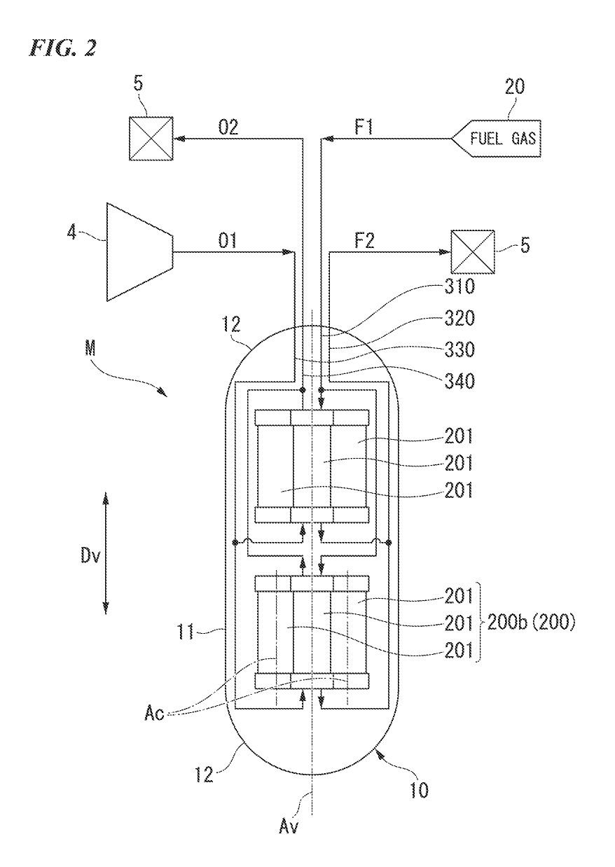

As shown in FIG. 2, the fuel cell module 2 has a cylindrical pressure vessel 10 that extends in a direction Dv of the vessel central axis Av centering on the vessel central axis Av, and a plurality of cartridges 201 that are disposed inside the pressure vessel 10.

The pressure vessel 10 is operated, for instance, under an internal pressure of 0.1 MPa to about 5.0 MPa at an internal temperature of an atmospheric temperature to about 550° C. For this reason, in consideration of pressure resistance, the pressure vessel 10 has a cylindrical body part 11 and hemispherical mirror parts 12 formed at both ends of the body part 11 in an axial direction of the body part 11. The pressure vessel 10 has a cylindrical shape as a whole, and is installed so that the vessel central axis Av thereof extends in a vertical direction. Further, since corrosion resistance to the oxidant such as oxygen contained in the oxidant gas O1 is also required in addition to the pressure resistance, the pressure vessel 10 is formed of for instance, a stainless based material such as SUS304.

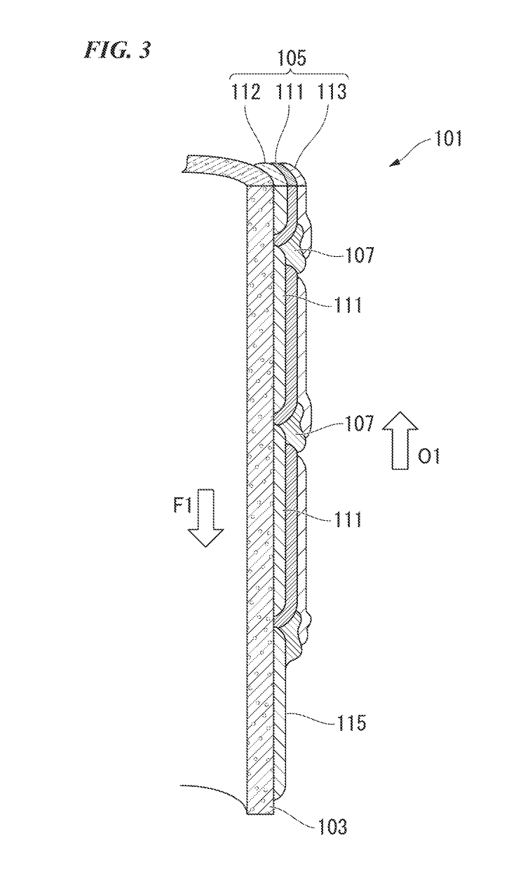

The cartridges 201 are each configured of a bundle of a plurality of cell stacks. As shown in FIG. 3, the cell stack 101 that is a cell assembly has a cylindrical (or tubular) substrate tube 103, a plurality of fuel cells 105 formed on an outer circumferential surface of the substrate tube 103, and interconnectors 107 that are each formed between the neighboring fuel cells 105. The fuel cells 105 are formed by stacking a fuel electrode 112, a solid electrolyte 111, and an air electrode 113. The cell stack 101 further includes a lead film 115 that is electrically connected to the air electrode 113 of one of the plurality of fuel cells 105 formed on the outer circumferential surface of the substrate tube 103, i.e. one formed at an axial extremity of the substrate tube 103, via the interconnectors 107. In the present embodiment, the cylindrical cell stack has been described. However, without being limited thereto, cell stacks having a planar shape, a flat oval shape, or the like may be used.

In the present embodiment, the fuel gas F1 flows on the inner circumference sides of the cylindrical (or tubular) cell stacks 101, and the oxidant gas O1 flows on the outer circumference sides of the cell stacks 101.

The substrate tube 103 is a porous tube formed of one of, for instance, CaO-stabilized ZrO₂ (CSZ), Y₂O₃-stabilized ZrO₂ (YSZ), and MgAl₂O₄. The substrate tube 103 supports the fuel cells 105, the interconnectors 107, and the lead film 115. Further, the substrate tube 103 also diffuses the fuel gas F1 fed to the inner circumference side thereof toward the fuel cells 105 formed on the outer circumferential surface of the substrate tube 103 via pores of the substrate tube 103.

The fuel electrode 112 is formed of an oxide of a composite material of nickel (Ni) and a zirconia-based electrolyte such as Ni/yttria-stabilized zirconia (YSZ). In this case, Ni that is a component of the fuel electrode 112 acts as a catalyst for the fuel gas F1. For example, when methane (CH₄) and water vapor are contained in the fuel gas F1 fed via the substrate tube 103, the catalyst causes mutual reaction of these and modifies these into hydrogen (H₂) and carbon monoxide (CO).

The air electrode 113 is formed of, for instance, a LaSrMnO₃-based oxide or a LaCoO₃-based oxide. The air electrode 113 dissociates oxygen in the fed oxidant gas O1 to generate oxygen ions (O²⁻) in the vicinity of an interface with the solid electrolyte 111.

The solid electrolyte 111 is mainly formed of, for instance, YSZ. The YSZ has airtightness making the passage of a gas difficult as well as high oxygen ion conductivity under a high temperature. The solid electrolyte 111 causes the oxygen ions (O²⁻) generated by the air electrode 113 to move to the fuel electrode 112.

In the fuel electrode 112 described above, the hydrogen (H₂) and the carbon monoxide (CO) obtained by the modification and the oxygen ions (O²⁻) fed from the solid electrolyte 111 react with each other in the vicinity of an interface with the solid electrolyte 111, and water (H₂O) and carbon dioxide (CO)) are generated. In the fuel cells 105, electrons are released from the oxygen ions in this reaction process, and electric power is produced.

The interconnector 107 is formed of, for instance, a conductive perovskite oxide expressed by M₁₋ₓL,TiO₃ (M is an alkaline earth metal, and L is a lanthanoid element) based on, for instance, SrTiO₃. The interconnector is a dense film so that the fuel gas F1 and the oxidant gas O1 are not mixed. The interconnector 107 has electric conductivity stabilized under both atmospheres of an oxidation atmosphere and a reduction atmosphere. The interconnector 107 electrically connects the air electrode 113 of a first fuel cell 105 of the neighboring fuel cells 105 and the fuel electrode 112 of a second fuel cell 105. That is, the interconnector 107 electrically connects the neighboring fuel cells 105 together in series.

The lead film 115 needs to have electron conductivity and a heat expansion coefficient similar to that of another material configuring the cell stack 101. Therefore, the lead film 115 is formed of a composite material of Ni and a zirconia-based electrolyte such as Ni/YSZ. The lead film 115 delivers direct-current power, which is produced by the multiple fuel cells 105 electrically connected in series by the interconnectors 107, up to the vicinity of an end of the cell stack 101.

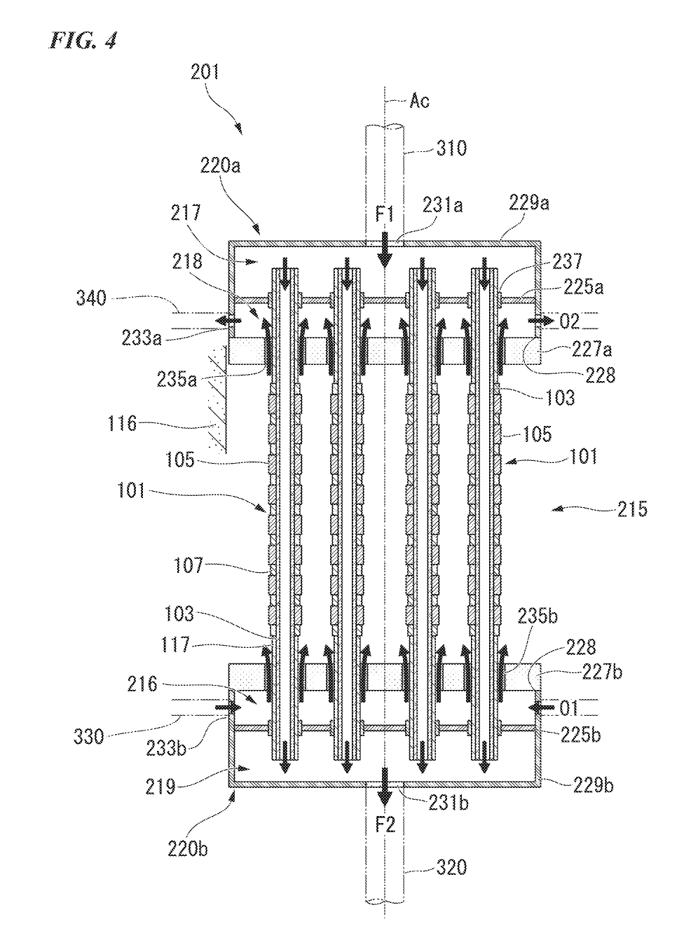

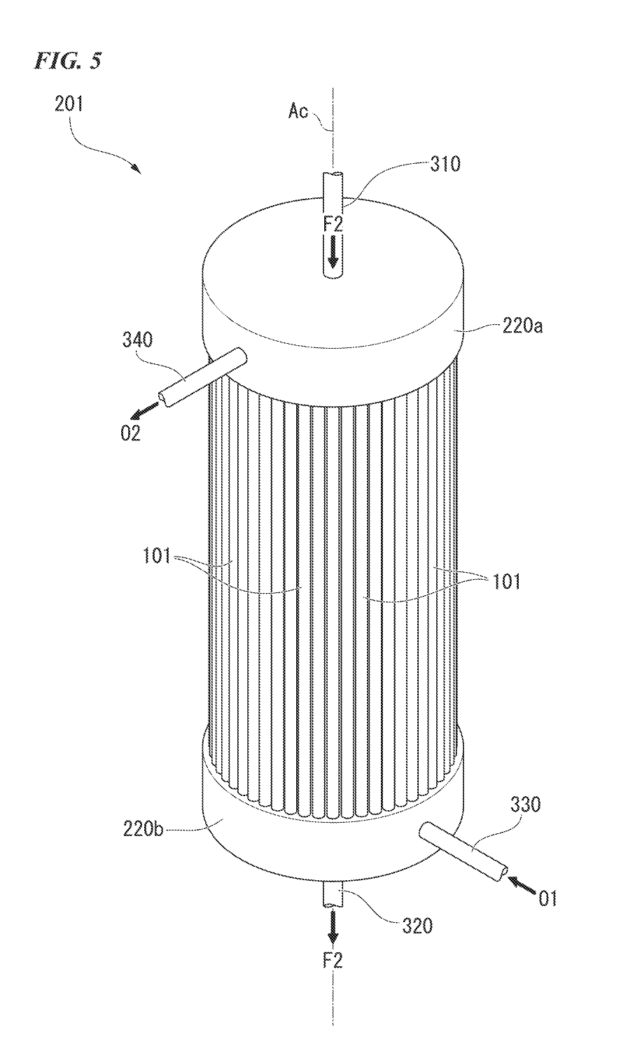

As shown in FIGS. 4 and 5, the cartridge 201 has the multiple cell stacks 101, a first cartridge header 220a covering a first end of the bundle of the multiple cell stacks 101, and a second cartridge header 220b covering a second end of the multiple cell stacks 101. The multiple cell stacks 101 are parallel to one another, and a longitudinal direction thereof are aligned each other, thereby forming a columnar shape as a whole. Further, the first cartridge header 220a and the second cartridge header 220b form a cylindrical shape having a slightly greater outer diameter than the bundle of the multiple cell stacks 101 forming the columnar shape. For this reason, the cartridge 201 forms a long columnar shape in the longitudinal direction of the cell stacks 101 as a whole.

Both the first cartridge header 220a and the second cartridge header 220b have cylindrical casings 229a and 229b into openings 228 of which the ends of the bundle of the multiple cell stacks 101 are inserted, heat insulators 227a and 227b that block the openings 228 of the casings 229a and 229b, and tube plates 225a and 225b that partition internal spaces of the casings 229a and 229b into two spaces in the longitudinal direction of the cell stacks 101. The tube plates 225a and 225b, etc., are formed of a metal material having high-temperature durability, such as Inconel (nickel-based alloys trademarked by Special Metals Corporation). The tube plates 225a and 225b and the heat insulators 227a and 227b are provided with through-holes into which the respective ends of the multiple cell stacks 101 can be inserted. The tube plates 225a and 225b support the ends of the multiple cell stacks 101 which are inserted into the through-holes via seal members or adhesives 237. For this reason, although the through-holes are formed in the tube plate 225a or 225b, airtightness of a first space in the casing 229a or 229b against a second space therein is secured by the tube plate 225a or 225b. Each through-hole of the heat insulator 227a or 227b has an inner diameter formed to be greater than the outer diameter of each cell stack 101 inserted thereinto. In other words, a gap 235a or 235b is formed between an inner circumferential surface of each through-hole of the heat insulator 227a or 227b and an outer circumferential surface of each cell stack 101 inserted into this through-hole.

A space defined by the casing 229a and the tube plate 225a of the first cartridge header 220a forms a fuel gas feed chamber 217 to which the fuel gas F1 is fed. The casing 229a is provided with a fuel gas feed hole 231 a which guides the fuel gas F1 from the fuel pipe 310 to the fuel gas feed chamber 217. The ends of the substrate tubes 103 of the multiple cell stacks 101 are located and opened in the fuel gas feed chamber 217. The fuel gas F1 guided from the fuel pipe 310 to the fuel gas feed chamber 217 flows into the substrate tubes 103 of the multiple cell stacks 101. In this case, the fuel gas F1 is distributed to the substrate tubes 103 of the multiple cell stacks 101 at a nearly even flow rate by the fuel gas feed chamber 217. For this reason, it is possible to make the amount of power produced by each of the multiple cell stacks 101 uniform.

A space defined by the casing 229b and the tube plate 225b of the second cartridge header 220b form a fuel gas discharge chamber 219 into which the fuel gas F1 passing inside the substrate tubes 103 of the cell stacks 101 flows. The casing 229b is provided with a fuel gas discharge hole 231b which guides the exhaust fuel gas F2 flowing into the fuel gas discharge chamber 219 to the exhaust fuel pipe 320. The ends of the substrate tubes 103 of the multiple cell stacks 101 are located and opened in the fuel gas discharge chamber 219. The fuel gas F1 passing inside the substrate tube 103 of each of the multiple cell stacks 101, as described above, flows into the fuel gas discharge chamber 219, and then is discharged outside the pressure vessel 10 through the exhaust fuel pipe 320.

A space defined by the casing 229b, the heat insulator 227b, and the tube plate 225b of the second cartridge header 220b form an oxidant gas feed chamber 216. The casing 229b is provided with an oxidant gas feed hole 233b which guides the oxidant gas O1 from the oxidant gas pipe 330 to the oxidant gas feed chamber 216. The oxidant gas O1 guided into the oxidant gas feed chamber 216 flows from the gap 235b between the inner circumferential surface of each through-hole of the heat insulator 227b and the outer circumferential surface of each cell stack 101 inserted into this through-hole to a power generation chamber 215 between the first cartridge header 220a and the second cartridge header 220b.

The fuel cells 105 of the multiple cell stacks 101 are disposed in the power generation chamber 215 between the first cartridge header 220a and the second cartridge header 220b. For this reason, the fuel gas F1 and the oxidant gas O1 are subjected to an electrochemical reaction in the power generation chamber 215, and the electric power is produced. Around a middle portion of the power generation chamber 215 in the longitudinal direction of the cell stacks 101, the temperature reaches about 700° C. to 1100° C. and becomes a high-temperature atmosphere during the normal operation of the fuel cell module 2. Further, the power generation chamber 215 is located between the first cartridge header 220a and the second cartridge header 220b, and is a space in which an outer circumference side thereof is surrounded by an inner heat insulating material 116 to be described below.

A space defined by the casing 229a, the heat insulator 227a, and the tube plate 225a of the first cartridge header 220a form an air discharge chamber 218 into which the exhaust oxidant gas O2 passing the power generation chamber 215 flows. The casing 229a is provided with an air discharge hole 233a which guides the exhaust oxidant gas O2 flowing into the air discharge chamber 218 to the exhaust oxidant gas pipe 340. The oxidant gas O1 in the power generation chamber 215 flows from the gap 235a between the inner circumferential surface of each through-hole of the heat insulator 227a and the outer circumferential surface of each cell stack 101 inserted into this through-hole into the air discharge chamber 218, and then is discharged outside the pressure vessel 10 through the exhaust oxidant gas pipe 340 as the exhaust oxidant gas O2.

As the temperature of the power generation chamber 215 increases, temperatures of the tube plates 225a and 225b of the cartridge header 220a and 220b increase. The heat insulators 227a and 227b of the first and second cartridge headers 220a and 220b inhibit the tube plates 225a and 225b from being reduced in strength by the temperature increase and from being corroded by the oxidant contained in the oxidant gas O1. Further, the heat insulators 227a and 227b also suppress thermal deformation of the tube plates 225a and 225b.

As described above, the oxidant gas O1 in the power generation chamber 215 and the fuel gas F1 passing inside the multiple cell stacks 101 disposed in the power generation chamber 215 are subjected to the electrochemical reaction by the multiple fuel cells 105 in the cell stacks 101. As a result, the electric power is produced by the multiple fuel cells 105.

Direct current obtained by the power generation at the multiple fuel cells 105 flows to the end sides of the cell stacks 101 via the interconnectors 107 provided between the multiple fuel cells 105, and flows into the lead films 115 of the cell stacks 101. Then, the direct current flows from the lead films 115 to current collector rods (not shown) of the cartridge 201 via a current collector plate (not shown), and flows out of the cartridge 201. The multiple current collector rods are connected together in series and/or in parallel. Among the current collector rods, one located on the most downstream side is connected to, for instance, an inverter (not shown). The direct current flowing out of the cartridge 201 flows to, for instance, the inverter via the multiple current collector rods connected in series and/or in parallel, is converted into alternating current here, and is supplied to a power load.

The fuel gas F1 flowing along the inner circumference side of the cell stack 101 and the oxidant gas O1 flowing along the outer circumference side of the cell stack 101 exchange heat via the cell stack 101. As a result, the fuel gas F1 is heated by the oxidant gas O1, whereas the oxidant gas O1 is cooled by the fuel gas F1. In the present embodiment, the fuel gas F1 and the oxidant gas O1 flow along the inner and outer circumference sides of the cell stack 101 in the opposite directions. For this reason, the heat exchange rate between the fuel gas F1 and the oxidant gas O1 is increased, and cooling efficiency of the oxidant gas O1 caused by the fuel gas F1 and heating efficiency of the fuel gas F1 caused by the oxidant gas O1 are increased. Therefore, in the present embodiment, the oxidant gas O1 is cooled at a temperature at which the tube plate 225a, etc., forming the first cartridge header 220a does not undergo buckling deformation, and then flows into the air discharge chamber 218 of the first cartridge header 220a. Further, in the present embodiment, the fuel gas F1 is pre-heated in the cell stacks 101 inside the power generation chamber 215 to a temperature suitable for the power generation without using a heater.

In the present embodiment, the fuel gas F1 and the oxidant gas O1 flow along the inner and outer circumference sides of the cell stack 101 in the opposite directions. That is, the fuel gas F1 and the oxidant gas O1 flow in the opposite directions, but this is not necessarily so. For example, the fuel gas F1 and the oxidant gas O1 may flow in the same direction at the inner and outer circumference sides of the cell stack 101. The oxidant gas O1 may flow in a direction orthogonal to the flow of the fuel gas F1.

As shown in FIG. 2, all the multiple columnar-shaped cartridges 201 are disposed in the pressure vessel 10 so that central axes Ac thereof are parallel with the vessel central axis Av of the pressure vessel 10. In other words, in the present embodiment, the cartridge central axes Ac extend in a vertical direction like the vessel central axis Av.

The cartridges 201 are not limited to the foregoing configuration, and the cartridges may be disposed to extend in a direction orthogonal to the central axis of the pressure vessel. Further, the cartridges are not limited to the columnar shape, and may be formed in a prismatic shape.

Next, an operation of the combined power generation system 1 according to the present embodiment will be described.

When the combined power generation system 1 is activated, the gas turbine 3 is activated, and then the fuel cell module 2 is activated. First, at the gas turbine 3, the air compressor 4 compresses the oxidant gas O1 introduced from the air feeder 21. The combustor 5 mixes and burns the oxidant gas O1 and the fuel gas F1 fed from the fuel feeder 20 via the fuel branch pipe 19. The turbine 6 is rotated by the burnt exhaust gas. Thereby, the electric generator 8 begins to produce electric power. Further, when the gas turbine 3 is activated, the entire oxidant gas O1 fed to the fuel cell module 2 by the air compressor 4 is set to be fed to combustor 5 via the air branch pipe 18.

In the fuel cell module 2, first, the oxidant gas O1 is fed to start raising the pressure and to initiate heating. In this case, an amount of the oxidant gas O1 flowing into the air branch pipe 18 is gradually reduced, and the oxidant gas O1 fed to the fuel cell module 2 is gradually increased. On the other hand, in the fuel cell module 2, the fuel gas F1, compressed air fed from a branch (not shown) of the oxidant gas pipe 330 (not shown), or an inert gas such as nitrogen is fed to the fuel electrode side to start raising the pressure. The oxidant gas O1 is compressed by the air compressor 4, and thereby is heated at a temperature of about 350 to 400° C. and discharged. As such, the fuel cell module 2 is also heated.

In this way, the fuel cell module 2 is activated by gradually increasing the fuel gas F1 and the oxidant gas O1 to perform the heating while raising the pressure. The fuel cell module 2 is heated by the feeding of the oxidant gas O1 and the combustion of the oxidant gas O1 inside the fuel cell module 2. When the pressure of the fuel cell module 2 reaches a predetermined pressure and pressure control of the cartridges 201 is stabilized, the switching valve 16 is switched, and the exhaust fuel gas F2 is introduced into the combustor 5.

Next, a method of producing the electric power during the normal operation will be described.

When the combined power generation system 1 is in normal operation, the oxidant gas O1 is compressed by the air compressor 4, and is fed to the cartridges 201 of the fuel cell module 2 via the oxidant gas pipe 330.

On one hand, the fuel gas F1 fed from the fuel feeder 20 is fed to the cartridges 201 of the fuel cell module 2 via the fuel pipe 310. The cartridge group 200 produces the electric power using the oxidant gas O1 and the fuel gas F1. The exhaust oxidant gas O2 used to produce the electric power is introduced from the cartridge group 200 to the combustor 5 via the exhaust oxidant gas pipe 340.

On the other hand, the exhaust fuel gas F2 is introduced into the combustor 5 via the exhaust fuel pipe 320. Here, the exhaust fuel gas F2 contains water vapor because water is generated by the power generation reaction under a high temperature. As the fuel recirculation blower 15 is driven, a part of the exhaust fuel gas F2 flows into the fuel pipe 310 via the fuel recirculation pipe 325.

In the combustor 5, the exhaust fuel gas F2 is burnt, and a high-temperature exhaust gas is generated. The high-temperature exhaust gas is introduced from the combustor 5 into the turbine 6, and rotatably drives the turbine 6.

The turbine 6 generates a rotational driving force from the introduced high-temperature exhaust gas, and rotatably drives the air compressor 4. The rotational driving force is also transmitted to the electric generator 8, and the electric power is produced.

In this way, in the combined power generation system 1, the electric power is produced by the fuel cell module 2 and the gas turbine 3.

According to the present embodiment, the heater 23 is installed on the exhaust fuel pipe 320 between a combustor side of the switching valve 16 and an inlet side of the combustor 5. Thereby, the exhaust fuel pipe 320 can be pre-heated.

Since the exhaust fuel pipe 320 is pre-heated by the heater 23, moisture contained in the exhaust fuel gas F2 can be prevented from being condensed and generating drainage by coming into contact with the inside of the exhaust fuel pipe 320 in a low-temperature state. Thereby, it is possible to prevent the condensed drainage from flowing into the combustor 5 of the gas turbine 3 and damaging the combustor 5 or the turbine blades constituting the turbine 6.

Further, since the exhaust fuel pipe 320 is disposed in the gas turbine exhaust gas duct 9, the heater 23 is operated by activating the gas turbine 3. As such, it is possible to pre-heat the exhaust fuel pipe 320 before the fuel cell and the gas turbine in the combined power generation system work together. Since the heater 23 does not require energy such as electric power, it is possible to prevent the plant efficiency from being reduced.

Furthermore, the structure in which the exhaust fuel pipe 320 passes through the interior of the gas turbine exhaust gas duct 9 is used. Thereby, the heater 23 can be configured by a simpler configuration.

The method of using the gas turbine exhaust gas duct 9 as the heat source is not limited to the foregoing method. The heater 23 may be configured to cause a part of the exhaust gas flowing along the gas turbine exhaust gas duct 9 to branch off into a small-diameter pipe with the small-diameter pipe disposed around the exhaust fuel pipe 320.

### Second Embodiment

Hereinafter, a combined power generation system according to a second embodiment of the present invention will be described based on the drawings. Note that the present embodiment will be described mainly with regard to portions different from those of the first embodiment described above, and that a description of portions similar to those of the first embodiment will be omitted here.

While the heater 23 of the combined power generation system 1 according to the first embodiment uses the gas turbine exhaust gas duct 9 as the heat source, the combined power generation system 1B of the present embodiment uses an exhaust oxidant gas pipe 340 as a heat source.

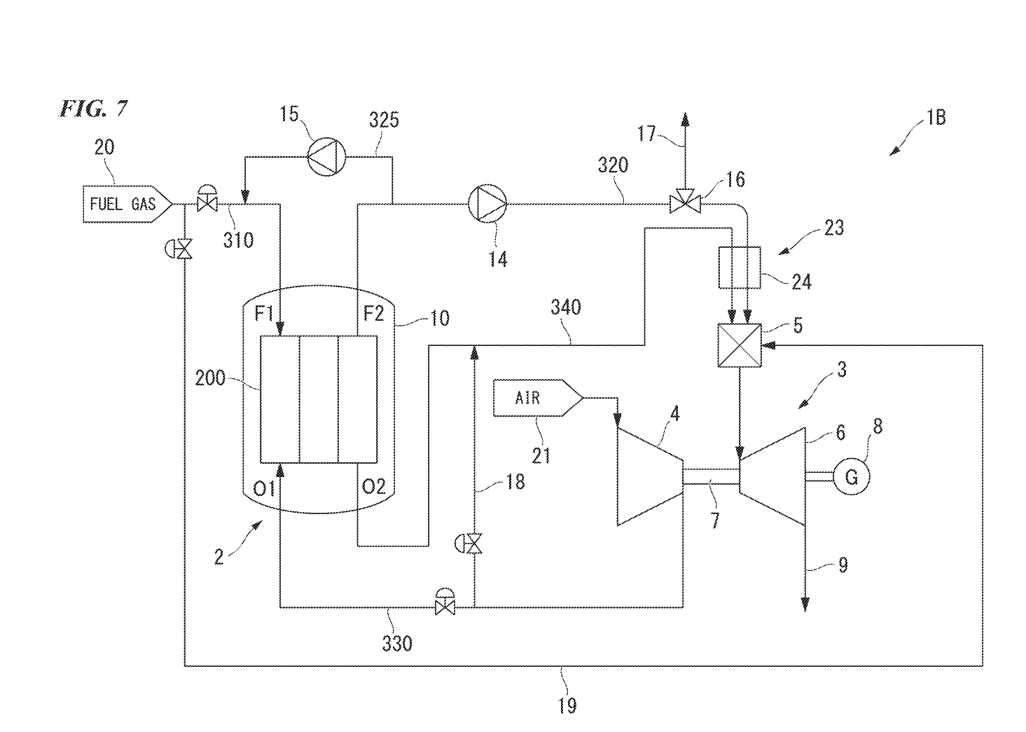

Specifically, as shown in FIG. 7, the exhaust oxidant gas pipe 340 and an exhaust fuel pipe 320 are partly arranged in parallel. A heat exchanger 24 is provided across the exhaust oxidant gas pipe 340 and the exhaust fuel pipe 320. The heat exchanger 24 exchanges heat between the exhaust oxidant gas pipe 340 and the exhaust fuel pipe 320. In other words, the heat exchanger 24 pre-heats the exhaust fuel pipe 320 using heat of the exhaust oxidant gas pipe 340. That is, a heater 23 of the present embodiment uses the exhaust oxidant gas pipe 340 as the heat source.

According to the present embodiment, the exhaust fuel pipe 320 between a combustor side of a switching valve 16 and an inlet side of a combustor 5 is pre-heated by the exhaust oxidant gas pipe 340 that is a high-temperature heat source. Thereby, moisture contained in an exhaust fuel gas F2 can be prevented from being condensed into drainage in the exhaust fuel pipe 320.

The heat exchange between the exhaust oxidant gas pipe 340 and the exhaust fuel pipe 320 is not limited to the use of the heat exchanger 24. The heater 23 may be configured so that heat insulation is performed on the exhaust oxidant gas pipe 340 and the exhaust fuel pipe 320 arranged in parallel, and thereby the heat of the exhaust oxidant gas pipe 340 is transmitted to the exhaust fuel pipe 320 by radiation and natural convection.

Furthermore, the heater 23 may be configured to cause a part of an exhaust oxidant gas O2 flowing along the exhaust oxidant gas pipe 340 to branch off into a small-diameter pipe with the small-diameter pipe disposed around the exhaust fuel pipe 320.

### Third Embodiment

Hereinafter, a combined power generation system according to a third embodiment of the present invention will be described based on the drawings. Note that the present embodiment will be described mainly with regard to portions different from those of the first embodiment described above, and that a description of portions similar to those of the first embodiment will be omitted here.

While the heater 23 of the combined power generation system 1 according to the first embodiment uses the gas turbine exhaust gas duct 9 as the heat source, the combined power generation system 1C of the present embodiment uses an oxidant gas pipe 330 as a heat source.

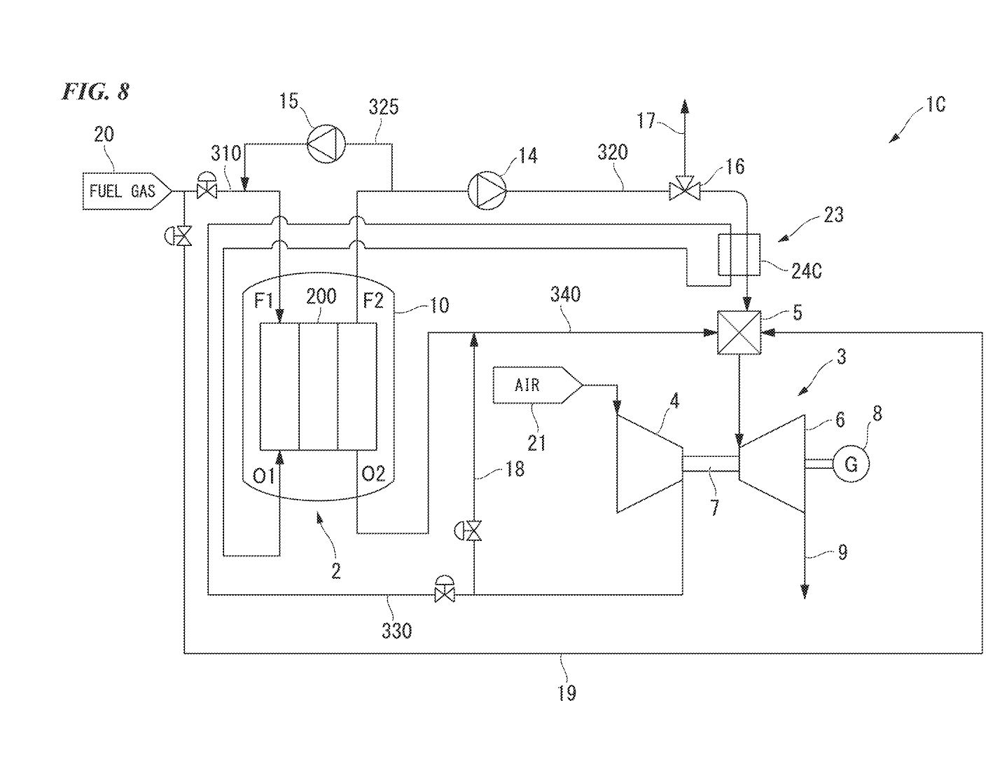

To be specific, as shown in FIG. 8, the oxidant gas pipe 330 and an exhaust fuel pipe 320 are partly arranged in parallel. A heat exchanger 24C is provided across the oxidant gas pipe 330 and the exhaust fuel pipe 320. The heat exchanger 24C exchanges heat between the oxidant gas pipe 330 and the exhaust fuel pipe 320. In other words, the heat exchanger 24C pre-heats the exhaust fuel pipe 320 using heat of the oxidant gas pipe 330. That is, a heater 23 of the present embodiment uses the oxidant gas pipe 330 as the heat source.

According to the present embodiment, the exhaust fuel pipe 320 between a combustor side of a switching valve 16 and an inlet side of a combustor 5 is pre-heated by the oxidant gas pipe 330 that is a high-temperature heat source. Thereby, moisture contained in an exhaust fuel gas F2 can be prevented from being condensed and generating drainage in the exhaust fuel pipe 320.

Similarly to the second embodiment, the heat exchange between the oxidant gas pipe 330 and the exhaust fuel pipe 320 is not limited to the heat exchanger 24C. The heater 23 may be configured so that heat insulation is performed on the oxidant gas pipe 330 and the exhaust fuel pipe 320 arranged in parallel, and thereby the heat of the oxidant gas pipe 330 is transmitted to the exhaust fuel pipe 320 by radiation and natural convection.

Furthermore, the heater 23 may be configured to cause a part of an oxidant gas O1 flowing along the oxidant gas pipe 330 to branch off into a small-diameter pipe with the small-diameter pipe disposed around the exhaust fuel pipe 320.

### Fourth Embodiment

Hereinafter, a combined power generation system according to a fourth embodiment of the present invention will be described based on the drawings. Note that the present embodiment will be described mainly with regard to portions different from those of the first embodiment described above, and that a description of portions similar to those of the first embodiment will be omitted here.

The combined power generation system 1D of the present embodiment uses a vent pipe 17 as a heat source.

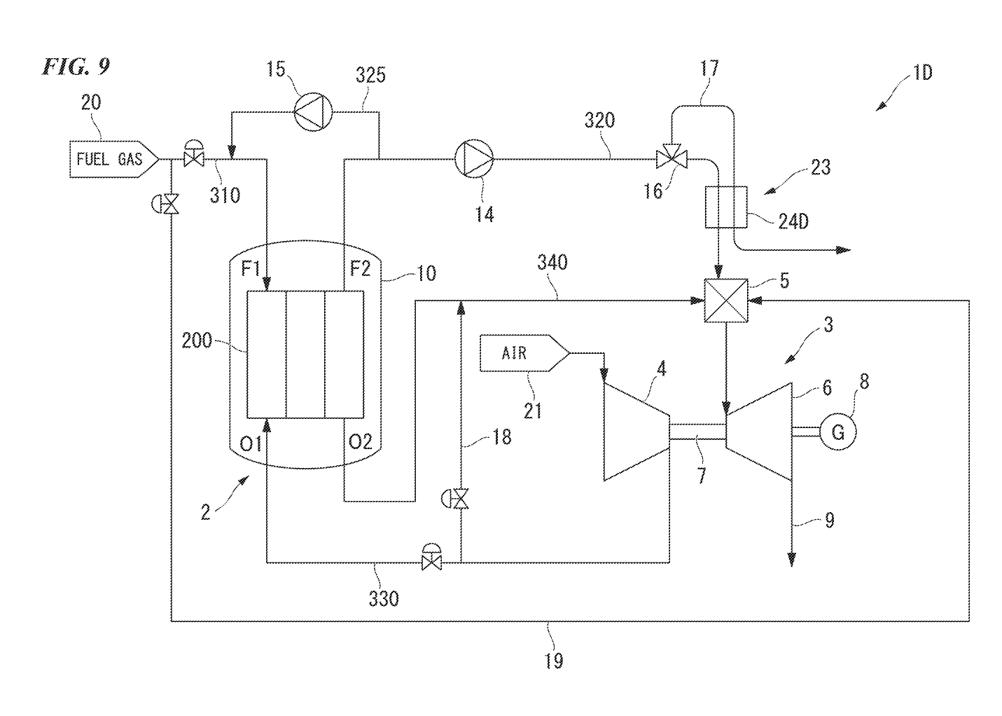

To be specific, as shown in FIG. 9, the vent pipe 17 and an exhaust fuel pipe 320 are partly arranged in parallel. A heat exchanger 24D is provided across the vent pipe 17 and the exhaust fuel pipe 320. That is, a heater 23 of the present embodiment uses the vent pipe 17 as the heat source.

According to the present embodiment, the exhaust fuel pipe 320 between a combustor side of a switching valve 16 and an inlet side of a combustor 5 is pre-heated by the vent pipe 17 that is a high-temperature heat source. Thereby, moisture contained in an exhaust fuel gas F2 can be prevented from being condensed and generating drainage in the exhaust fuel pipe 320.

The heat exchange between the vent pipe 17 and the exhaust fuel pipe 320 is not limited to the heat exchanger 24D. The heater 23 may be configured so that heat insulation is performed on the vent pipe 17 and the exhaust fuel pipe 320 arranged in parallel, and thereby the heat of the vent pipe 17 is transmitted to the exhaust fuel pipe 320 by radiation and natural convection.

Furthermore, the heater 23 may be configured to cause a part of the exhaust fuel gas F2 flowing along the vent pipe 17 to branch off into a small-diameter pipe with the small-diameter pipe disposed around the exhaust fuel pipe 320.

### Fifth Embodiment

Hereinafter, a combined power generation system according to a fifth embodiment of the present invention will be described based on the drawings. Note that the present embodiment will be described mainly with regard to portions different from those of the first embodiment described above, and that a description of portions similar to those of the first embodiment will be omitted here.

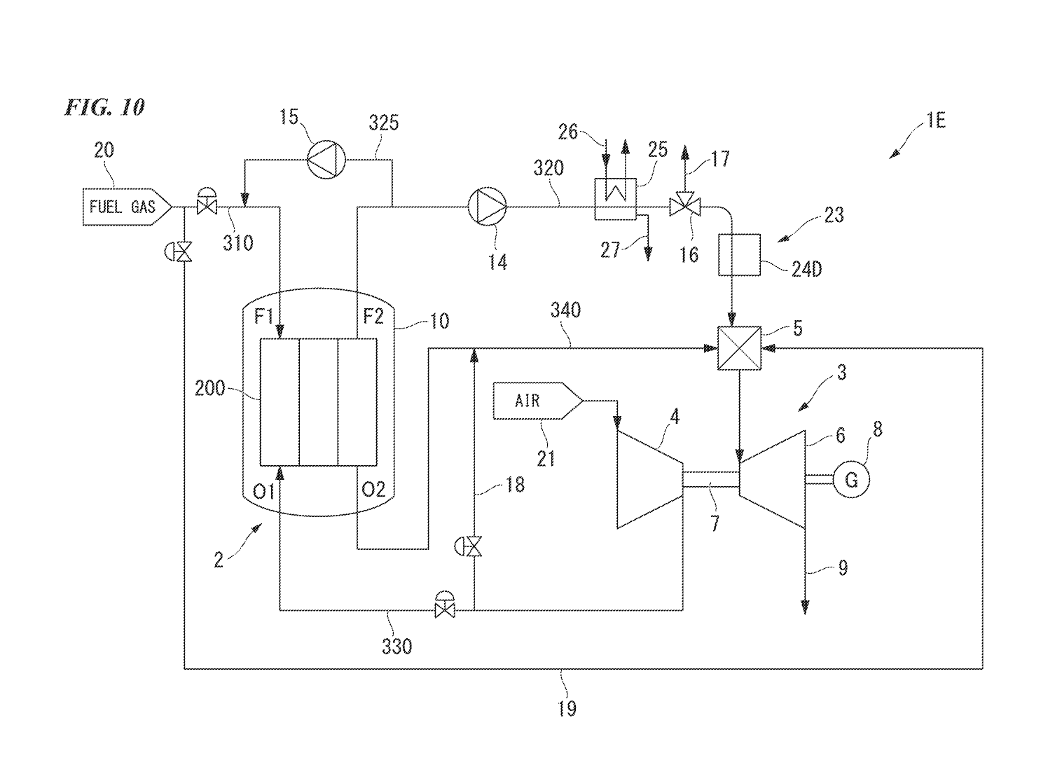

As shown in FIG. 10, in the combined power generation system 1E of the present embodiment, a drainage separator 25 is installed on an exhaust fuel pipe (exhaust fuel line) 320 into which an exhaust fuel gas F2 is introduced. The drainage separator 25 is installed, and thereby the exhaust fuel gas F2 from which the drainage is separated is fed to a downstream side of the drainage separator 25. Thereby, the drainage is prevented from being generated in the exhaust fuel pipe 320 between a combustor side of a switching valve 16 and an inlet side of a combustor 5.

The drainage separator 25 cools the exhaust fuel gas F2 to remove moisture contained in the exhaust fuel gas F2. The exhaust fuel gas F2 is fed to the exhaust fuel pipe (exhaust fuel line) 320 downstream from the switching valve 16. The drainage separator 25 is preferably disposed upstream from the switching valve 16 of the exhaust fuel pipe 320.

As a cooling means of the drainage separator 25, a coolant having a lower temperature than the exhaust fuel gas F2 is supplied to a channel 26, and exchanges heat with the exhaust fuel gas F2, thereby condensing the drainage. The coolant is not particularly limited. Liquefied natural gas (LNG) or condensed water of the steam turbine of the combined power generation system may be used as the coolant to recover heat of the exhaust fuel gas F2 in the system, and thereby contribute to improving efficiency as the combined power generation system.

The drainage condensed by the drainage separator 25 may be discharged by a drainage channel 27, and be recycled as moisture added to the fuel gas Fl.

In the present embodiment, the exhaust fuel gas F2 from which the drainage is separated is heated by a heater 23, and thereby stabilized combustion can be realized in the combustor. In the present embodiment, as the heater 23, heating based on catalyst combustion installed on the exhaust fuel pipe (exhaust fuel line) 320 is applied. Air required to carry out the catalyst combustion may be ramified and fed from an oxidant gas pipe (oxidant gas line) 330 (not shown), or a separately provided air feed line may be used.

Here, the catalyst combustion is generically defined as combustion including an oxidation reaction and a combustion reaction. As the heating portion in the present embodiment, a typical combustion method such as a burner may be applied in addition to the catalyst combustion. Further, as the heating portion, one or more of the first to fourth embodiments may be applied.

Since the exhaust fuel gas F2 is subjected to the drainage separation by the drainage separator 25 and heats the exhaust fuel cooled by the drainage separation using the heater 23, the exhaust fuel gas F2 flows into the low-temperature exhaust fuel pipe (exhaust fuel line) 320 in the process of activating the combined power generation system. Thereby, it is possible to prevent the condensed drainage from being generated.

The technical scope of the present invention is not limited to the aforementioned embodiments, but the present invention may be modified in various ways without departing from the spirit or scope of the present invention.

For example, the heater 23 may be configured to employ an independent heat source such as an electric heater and pre-heat exhaust fuel pipe 320.

### INDUSTRIAL APPLICABILITY

According to the aforementioned power generation system, the power generation system can prevent a combustor or turbine blades from being damaged when switching to normal operation in which a fuel cell and gas turbine of the power generation system work together with each other.

### REFERENCE SIGNS LIST

1: combined power generation system

2: fuel cell module (fuel cell)

3: gas turbine

4: air compressor

5: combustor

6: turbine

9: gas turbine exhaust gas duct

16: switching valve (switching unit)

17: vent pipe (branch exhaust fuel line)

23: heater (heating portion)

24: heat exchanger

25: drainage separator

26: channel

27: drainage channel

310: fuel pipe (fuel line)

320: exhaust fuel pipe (exhaust fuel line)

330: oxidant gas pipe (oxidant gas line)

340: exhaust oxidant gas pipe (exhaust oxidant gas line)

F1: fuel gas

F2: exhaust fuel gas

O1: oxidant gas

O2: exhaust oxidant gas

What is claimed is:

1. A power generation system comprising:
a fuel cell that generates electric power using a fuel gas;
a gas turbine including an air compressor, a combustor, and a turbine;
an exhaust fuel line that introduces an exhaust fuel gas discharged from the fuel cell into the combustor;
a branch exhaust fuel line branching off midway from the exhaust fuel line;
a switching unit that sends the exhaust fuel gas to one of the branch exhaust fuel line and the combustor; and
a heating portion that heats the exhaust fuel line at a downstream side of the switching unit.

2. The power generation system according to claim 1, further comprising a gas turbine exhaust gas duct that emits an exhaust gas discharged from the turbine,
wherein the heating portion uses the exhaust gas passing the gas turbine exhaust gas duct as a heat source.

3. The power generation system according to claim 2,
wherein the exhaust fuel line passes through an interior of the gas turbine exhaust gas duct.

4. The power generation system according to claim 1, further comprising an exhaust oxidant gas line that introduces an oxidant gas discharged from the fuel cell into the combustor,
wherein the heating portion uses the exhaust oxidant gas passing through the exhaust oxidant gas line as a heat source.

5. The power generation system according to claim 1, further comprising an oxidant gas line that introduces an oxidant gas discharged from the air compressor into the fuel cell,
wherein the heating portion uses the oxidant gas passing through the oxidant gas line as a heat source.

6. The power generation system according to claim 1, wherein the heating portion uses the exhaust fuel gas passing through the branch exhaust fuel line as a heat source.

7. The power generation system according to claim 1, further comprising a drainage separator that separates moisture contained in the exhaust fuel gas,
wherein the drainage separator is installed on the exhaust fuel line at an upstream side of the switching unit.
